(19) United States
(12) Patent Application Publication
(10) Pub. No.: US 2024/0012981 A1
(43) Pub. Date: Jan. 11, 2024

(54) DISPLAY CONTROL SYSTEM, DISPLAY CONTROL METHOD, AND DISPLAY CONTROL PROGRAM

(71) Applicant: Nippon Telegraph and Telephone Corporation, Tokyo (JP)

(72) Inventors: Hidetaka Koya, Musashino-shi, Tokyo (JP); Makoto Komiyama, Musashino-shi, Tokyo (JP); Akira Kataoka, Musashino-shi, Tokyo (JP)

(21) Appl. No.: 18/035,058

(22) PCT Filed: Nov. 4, 2020
(86) PCT No.: PCT/JP2020/041268

§ 371 Date: May 2, 2023

(51) Int. Cl. G06F 40/14; G06F 9/451; G06F 16/958; G06F 16/93

(52) U.S. Cl. CPC G06F 40/14; G06F 9/451; G06F 16/986; G06F 16/93

(57) ABSTRACT

A display control system (1) includes an acquisition unit (153) and a search unit (154). The acquisition unit (153) acquires a DOM tree of a screen into which an additional UI is inserted. The search unit (154) searches for UIs used for display control of the additional UI from a base point UI serving as a base point of display of the additional UI in the DOM tree on the basis of a display condition related to display of the additional UI.

### TECHNICAL FIELD

The present disclosure relates to a display control system, a display control method, and a display control program.

### BACKGROUND ART

Web systems have been developed for various types of business. The screen of a web system is important to be updated in accordance with the actual state of business. However, screen modification may require significant costs. Furthermore, screen modification may have unexpected influence on the web system. Therefore, UI extension technique has been proposed in order to adapt a screen to changes in business without directly modifying the screen.

In the UI extension technique, an additional UI is displayed without the screen of an existing web system being directly modified. In the UI extension technique, in order to reduce the influence of an additional UI on the existing web system, an additional UI is inserted at the end of a document object model (DOM) tree that forms the screen of the existing web system.

In a case where the additional UI is inserted at the end of the DOM tree, a base point user interface (UI) serving as a base point of display is specified for the additional UI. A base point UI is a UI existing on the screen of the existing web system. In a case where this base point UI is displayed on the screen, the additional UI is displayed on the screen on the basis of the relative coordinates from the base point UI.

A method for controlling display of an additional UI as described above may require complex display and hiding of an additional UI and controlling the display position of an additional UI. For example, in such a method, a UI including a scroll region may be searched for from a DOM tree of a screen to cause an additional UI to follow scrolling of the UI that exists on the screen of the web system. The UI including a scroll region is an example of a UI used for display control of an additional UI.

### CITATION LIST

### Patent Literature

Patent Literature 1: JP 2018-5344 A

### SUMMARY OF INVENTION

### Technical Problem

However, in an existing method for controlling display of an additional UI, an UI used for display control of an additional UI may not be able to be efficiently searched for.

For example, in the existing method, an exhaustive search of UIs used for display control of an additional UI is performed from the root of a DOM tree of a screen. However, if the structure of the DOM tree is huge or the change scale of the DOM tree is large, a UI search may take a long time. In the worst case, the web system freezes.

The present application has been made in view of the above, and an object thereof is to efficiently search for UIs used for display control of an additional UI.

### Solution to Problem

A display control system according to the present disclosure includes an acquisition unit that acquires a DOM tree of a screen into which an additional UI is inserted, a search unit that searches for UIs used for display control of the additional UI from a base point UI serving as a base point of display of the additional UI in the DOM tree on a basis of a display condition related to display of the additional UI, and a registration unit that registers an event according to the display condition for UIs that have been searched for by the search unit.

### Advantageous Effects of Invention

According to an aspect of the embodiment, a search for UIs used for display control of an additional UI can be efficiently performed.

### BRIEF DESCRIPTION OF DRAWINGS

FIG. 1 is an explanatory diagram illustrating an example of a UI extension.

FIG. 2 is an explanatory diagram illustrating an example of a typical UI search.

FIG. 3 is an explanatory diagram illustrating an example of a UI search according to an implementation example.

FIG. 4A is an explanatory diagram illustrating an example of display control of an additional UI.

FIG. 4B is an explanatory diagram illustrating an example of display control of an additional UI.

FIG. 4C is an explanatory diagram illustrating an example of display control of an additional UI.

FIG. 5 is a diagram illustrating an example of a display control system according to an embodiment.

FIG. 6 is a flowchart illustrating an example of processing for detecting that an additional UI has been inserted performed by a terminal device according to the embodiment.

FIG. 7 is an explanatory diagram illustrating an example of a typical UI search.

FIG. 8 is an explanatory diagram illustrating an example of a UI search according to an implementation example.

FIG. 9 is an explanatory diagram illustrating an example of information held in a storage unit.

FIG. 10A is an explanatory diagram illustrating an example of search processing of searching for UIs used for display control of additional UIs.

FIG. 10B is an explanatory diagram illustrating an example of search processing of searching for UIs used for display control of additional UIs.

FIG. 11A is an explanatory diagram illustrating an example of search processing of searching for UIs used for display control of additional UIs.

FIG. 11B is an explanatory diagram illustrating an example of search processing of searching for UIs used for display control of additional UIs.

FIG. 12A is an explanatory diagram illustrating an example of search processing of searching for UIs used for display control of additional UIs.

FIG. 12B is an explanatory diagram illustrating an example of search processing of searching for UIs used for display control of additional UIs.

FIG. 13 is a flowchart illustrating an example of event processing according to a display condition performed by the terminal device according to the embodiment.

FIG. 14 is an explanatory diagram illustrating an example of screen display when an event occurs.

FIG. 15 is a flowchart illustrating an example of event processing according to a display condition performed by the terminal device according to the embodiment.

FIG. 16 is an explanatory diagram illustrating an example of screen display when an event occurs.

FIG. 17 is a flowchart illustrating an example of event processing according to a display condition performed by the terminal device according to the embodiment.

FIG. 18 is an explanatory diagram illustrating an example of screen display when an event occurs.

FIG. 19 is a flowchart illustrating an example of processing for searching for UIs used for display control of an additional UI performed by the terminal device according to the embodiment.

FIG. 20 is a diagram illustrating an example of a hardware configuration.

### DESCRIPTION OF EMBODIMENTS

Embodiments of the present disclosure will be described below in detail with reference to the drawings. Note that the present invention is not limited by these embodiments. Details of one or more embodiments are set forth in the following description and drawings. Note that a plurality of the embodiments can be appropriately combined without causing contradiction in processing contents. In the following one or more embodiments, the same portions are denoted by the same reference numerals, and redundant description will be omitted.

Hereinafter, a “UI that is additional” may be referred to as an “additional UI”. Furthermore, a “UI that is existing” may be referred to as an “existing UI”.

### 1. Outline

This section describes an outline of some forms of implementation described in the present specification. Note that this outline is provided for the convenience of a reader and is not intended to limit the present invention or the embodiment described in the following sections.

Conventionally, various types of UI extension technique have been proposed. One type of the UI extension technique is web function extension technique in which an additional UI is inserted at the end of a DOM tree that forms an existing system screen. In the web function extension technique, an additional UI can be displayed without influence of directly modifying a screen of the existing web system being caused.

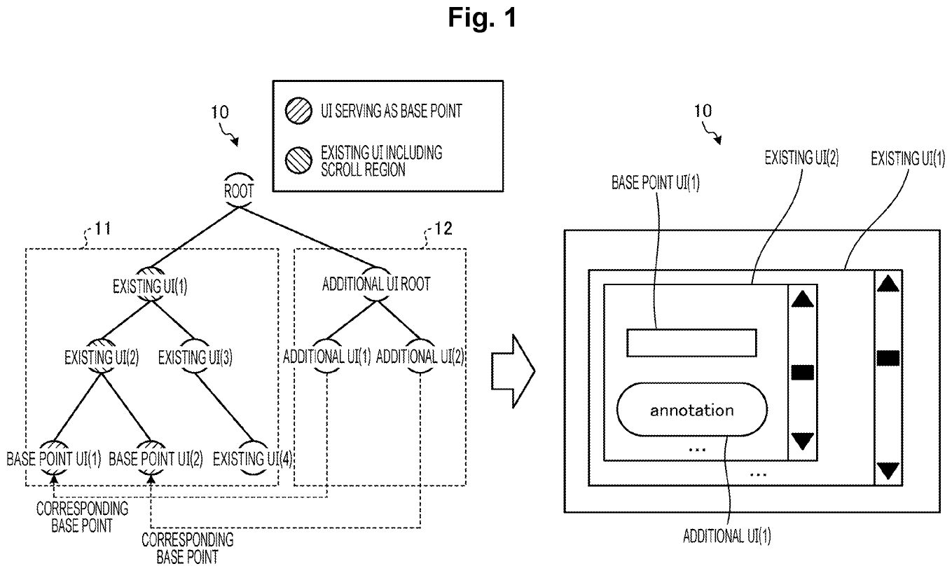

FIG. 1 is an explanatory diagram illustrating an example of a UI extension. In the example of FIG. 1, a DOM tree 10 of a screen of a web system includes a DOM tree 11 of the screen of the existing web system and a DOM tree 12 of additional UIs. The arrow illustrated in FIG. 1 illustrates correspondence between the DOM tree 10 of the screen and the appearance of the screen.

In the web function extension technique, base point UIs are specified for additional UIs. Base point UIs are UIs existing in the existing web system. In a case where a UI serving as a base point is displayed on the screen of the web system, an additional UI is displayed using relative coordinates from the UI serving as the base point. In a case where an existing UI that is hierarchically a parent of an additional UI changes, display control of the additional UI may be required according to the change of the existing UI.

For example, in the web function extension technique, existing UIs involving a change in display mode are searched for for display control of an additional UI. The existing UIs involving a change in display mode are, for example, existing UIs including scroll regions. In the example of FIG. 1, an additional UI (1) does not actually exist as a child of an existing UI (2). Therefore, if display control of an additional UI is not performed, the additional UI (1) does not follow scrolling of the existing UI (2).

Therefore, in the web function extension technique, existing UIs involving a change in display mode are searched for. Such existing UIs exist in the parent hierarchy of UIs that are set as base points of additional UIs and are UIs involving a change in a display mode. For example, the existing UIs that are searched for are existing UIs including scroll regions.

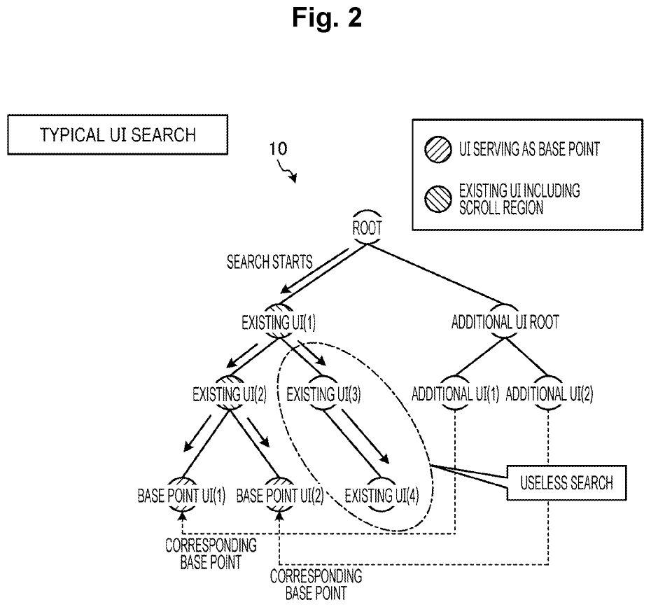

FIG. 2 is an explanatory diagram illustrating an example of a typical UI search. In the typical UI search, UIs used for display control are exhaustively searched for from the root in order to respond to a dynamic change in the DOM tree 10. For this reason, the computational complexity of the typical UI search is enormous and only a change in scrolling of the parent is responded to.

In the example of FIG. 2, an existing UI including a scroll region is not under an existing UI (1), but an existing UI (3) and an existing UI (4) are also searched. As described above, in the typical UI search, a useless search occurs. Furthermore, in a case where a change in a tree is large, the amount of computational complexity required for a UI search increases. In the worst case, the existing system freezes.

Therefore, in a case where an additional UI is inserted, a display control system according to an implementation example searches for a plurality of UIs used for display control of the additional UI using a UI serving as a base point as a base point. As a result, the display control system can efficiently identify UIs with a small computational complexity.

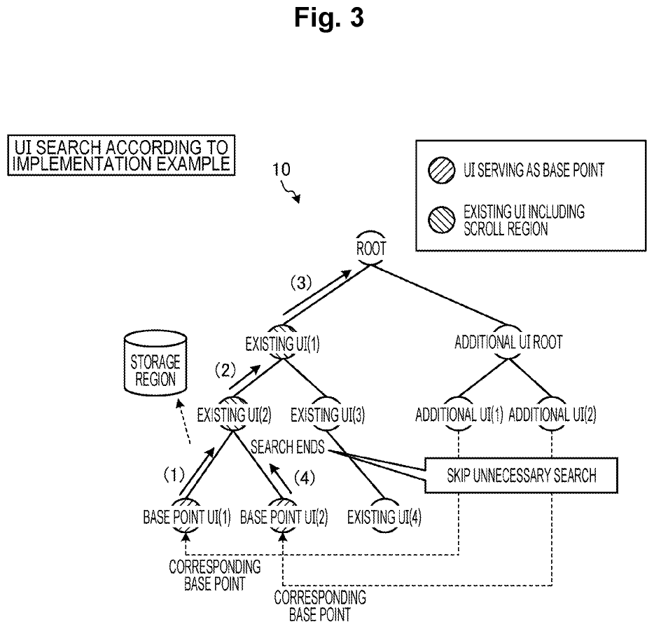

FIG. 3 is an explanatory diagram illustrating an example of a UI search according to the implementation example. The display control system searches for existing UIs from UIs serving as base points toward the parents in the DOM tree 10. Existing UIs to be searched for are existing UIs involving a change in display mode such as existing UIs including scroll regions. The change in display mode may be a change in transmittance, size, z-index, or the like.

The display control system searches for UIs from the UIs serving as base points toward the root, and stores sets of keys that have been searched (UIs serving as base points or existing UIs) and values (display conditions) in a storage region. In a case where the display control system finds a set of a key and a value already stored in the storage region, the display control system skips a search of the subsequent UIs. In this manner, the display control system can skip an unnecessary search on the basis of the sets of keys and values stored in the storage region. Then, the display control system registers display control processing according to a display condition for an event of an existing UI.

As a result, the display control system can reduce the computational complexity of the UI search and speed up display of UIs. Furthermore, the display control system can flexibly perform display control of an additional UI according to a display condition set for the additional UI (for example, to follow scrolling of the parent or to follow the transmittance of the parent).

### 2. Introduction

Today, various systems are used for business. Since the actual state of business changes every day, a business system is important to be updated according to the actual state of the business. For example, it is assumed that a new menu is added to a service. In this example, if the business system does not support the new menu, a user of the business system cannot perform business related to the new menu on the business system.

Therefore, UI extension technique has been proposed so that business systems are updated in a timely manner. UI extension technique for extending UIs of a business system is discussed in detail in Patent Literature 1 described above, for example. In the UI extension technique, display of a UI added to a screen of a business system is controlled.

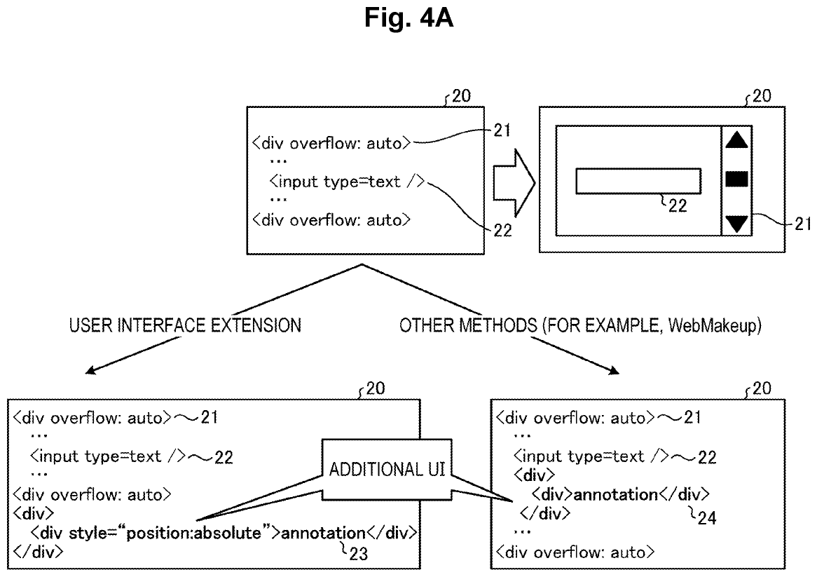

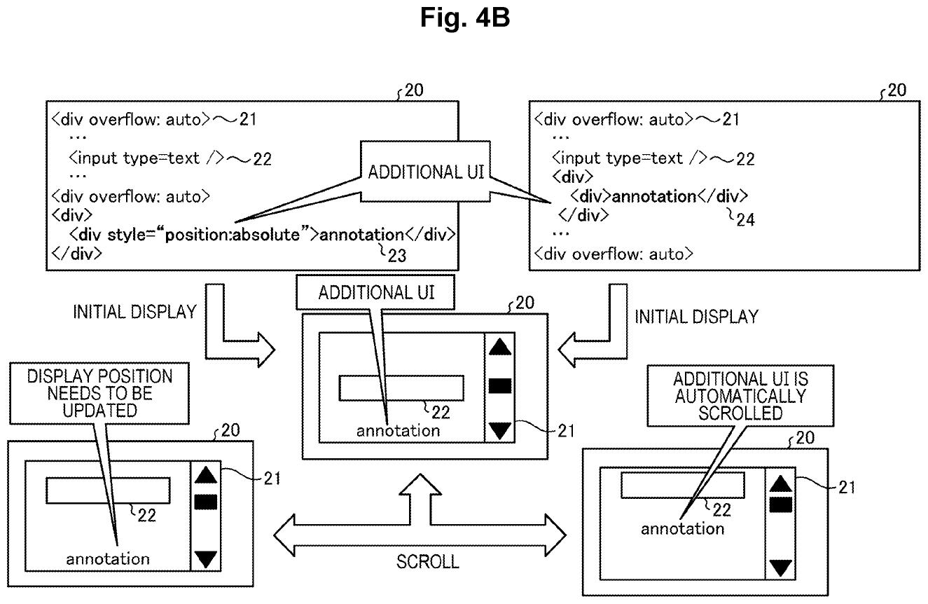

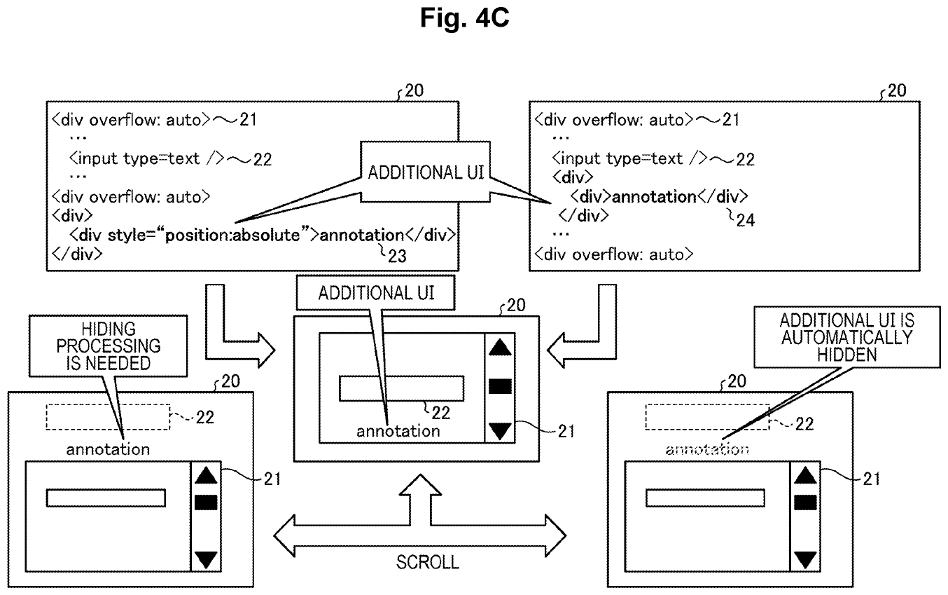

FIGS. 4A, 4B, and 4C are explanatory diagrams illustrating examples of display control of an additional UI. In the examples of FIGS. 4A, 4B, and 4C, an additional UI is inserted into a screen 20 of an existing system. The screen 20 of the existing system includes a UI 21. The UI 21 includes a UI 22. The arrow illustrated in FIG. 4A illustrates correspondence between a DOM of the screen 20 and the appearance of the screen 20.

In an example of FIG. 4A, an additional UI is inserted below the UI 22 using the UI 22 as a base point. For example, in a method such as WebMakeup, a UI 23 is inserted in the middle of the DOM tree of the screen 20. However, because the hierarchical structure of the existing DOM tree is broken, the system may be affected. Therefore, in the method of Patent Literature 1, the influence on the system is reduced by the UI 23 being inserted at the end of the DOM tree of the screen 20. The display control system according to the embodiment relates to the latter method.

In an example of FIG. 4B, a label of “annotation” is initially displayed as an additional UI (for example, the UI 23 or a UI 24). Then, a scrolling event occurs in the UI 21. In a method such as WebMakeup, the additional UI is automatically scrolled. However, in the method of Patent Literature 1, since the additional UI is not scrolled as it is, the method of Patent Literature 1 needs detecting that the UI 22 is scrolled and updating the display position of the additional UI.

In an example of FIG. 4C, an additional UI follows a scrolling event occurring at the UI 21 by the display position of the additional UI being controlled. In a method such as WebMakeup, in a case where the additional UI is outside the scroll region, the additional UI is automatically hidden. However, in the method of Patent Literature 1, since the additional UI remains displayed as it is, the method of Patent Literature 1 needs hiding processing of detecting that the UI 22 is scrolled and determining that a UI serving as a base point is outside the display region.

As described above, a UI extension method such as the method of Patent Literature 1 may need display control of an additional UI. For example, in the display control, a scrolling event is detected for UIs including scroll regions existing in the existing system. In order to implement such display control, UIs including scroll regions are searched for in an existing method. More specifically, in the existing method, the UIs including scroll regions are exhaustively searched for from the root of a DOM tree at timing when the DOM tree is updated. Then, in the existing method, event registration processing of registering display update processing of an additional UI at the time of scrolling is performed on the UIs that have been searched for.

As described above, in a case where existing UIs involve a change such as scrolling, in a UI extension method, display control of an additional UI may need to be performed in accordance with the change of the existing UIs that are parents of the additional UI in a hierarchical manner. As described above, in the existing method, existing UIs used for display control are exhaustively searched for from the root of a DOM tree in order to respond to a change in the existing UIs. However, in a case where the DOM tree is large, the computational complexity of the UI search increases, and display may be delayed.

Therefore, the display control system according to the embodiment efficiently searches for existing UIs used for display control of an additional UI such as UIs including scroll regions. As a result, the display control system can reduce delay in display even in a case where the DOM tree is large.

### 3. Configuration of Display Control System

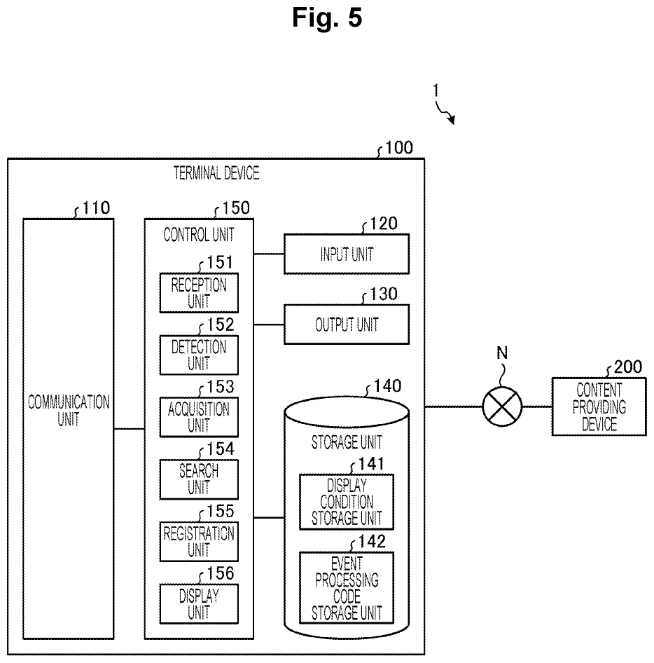

Next, a configuration example of the display control system according to the embodiment will be described with reference to FIG. 5.

FIG. 5 is a diagram illustrating an example of a display control system 1 according to the embodiment. As illustrated in FIG. 5, the display control system 1 includes a terminal device 100 and a content providing device 200. Although not illustrated in FIG. 5, the display control system 1 may include a plurality of terminal devices 100 and a plurality of content providing devices 200.

In the display control system 1, each of the terminal device 100 and the content providing device 200 is connected to a network N in a wired or wireless manner. The network N is, for example, the Internet, a wide area network (WAN), or a local area network (LAN). Components of the display control system 1 can communicate with each other via the network N.

[3-1. Components]

The terminal device 100 is an information processing device that performs processing for searching for UIs used for display control of an additional UI. The terminal device 100 may be any type of information processing device including a client device. A configuration example of the terminal device 100 will be described in detail in the following section.

The content providing device 200 is an information processing device used by a content provider. The content provider provides content such as a screen of the system to the terminal device 100. The content providing device 200 can insert an additional UI into the content. The content providing device 200 may be any type of information processing device including a server.

[3-2. Configuration of Terminal Device]

Next, a configuration example of the terminal device 100 will be described.

As illustrated in FIG. 5, the terminal device 100 includes a communication unit 110, an input unit 120, an output unit 130, a storage unit 140, and a control unit 150.

(Communication unit 110)

The communication unit 110 is formed by using, for example, a network interface card (NIC). The communication unit 110 is connected to a network in a wired or wireless manner. The communication unit 110 may be communicably connected to the content providing device 200 via the network N. The communication unit 110 can transmit and receive information to and from the content providing device 200 via the network.

(Input unit 120)

The input unit 120 is an input device that receives various operations from a user of the terminal device 100. For example, the input unit 120 is implemented using a keyboard, a mouse, an operation key, or the like.

(Output unit 130)

The output unit 130 is a display device for displaying various types of information. For example, the output unit 130 is implemented using a liquid crystal display, an organic electro luminescence (EL) display, or the like. Note that, in a case where a touch panel is adopted for the terminal device 100, the input unit 120 and the output unit 130 are integrated.

(Storage Unit 140)

The storage unit 140 is implemented using, for example, a semiconductor memory element such as a random access memory (RAM) or a flash memory, or a storage device such as a hard disk or an optical disk. As illustrated in FIG. 4, the storage unit 140 includes a display condition storage unit 141 and an event processing code storage unit 142.

(Display Condition Storage Unit 141)

The display condition storage unit 141 stores display conditions used for searching for existing UIs. The display condition storage unit 141 stores the display conditions determined by a search unit 154 to be described below. The display condition storage unit 141 stores caches of existing UIs searched for by the search unit 154 to be described below as display conditions.

(Event Processing Code Storage Unit 142)

The event processing code storage unit 142 stores an event processing code used for display control of an additional UI. The event processing code storage unit 142 stores an event processing code registered by a registration unit 155 to be described below.

(Control Unit 150)

The control unit 150 is a controller, and is implemented using, for example, a processor such as a central processing unit (CPU) or a micro processing unit (MPU) performing various programs (corresponding to an example of a display control program) stored in a storage device inside the terminal device 100 using a RAM or the like as a work area. Alternatively, the control unit 150 may be implemented using, for example, an integrated circuit such as an application specific integrated circuit (ASIC), a field programmable gate array (FPGA), or a general purpose graphic processing unit (GPGPU).

As illustrated in FIG. 5, the control unit 150 includes a reception unit 151, a detection unit 152, an acquisition unit 153, the search unit 154, the registration unit 155, and a display unit 156, and implements or performs a function and an action of information processing to be described below. One or more processors of the terminal device 100 can implement a function of each control unit in the control unit 150 by performing an instruction stored in one or more memories of the terminal device 100. Note that the internal configuration of the control unit 150 is not limited to the configuration illustrated in FIG. 5, and may be another configuration as long as information processing to be described below is performed. For example, the search unit 154 may perform all or part of information processing to be described below for a unit other than the search unit 154.

(Reception Unit 151)

The reception unit 151 receives content such as a screen of the system from the content providing device 200. The reception unit 151 may store the received content in the storage unit 140.

(Detection Unit 152)

The detection unit 152 detects that an additional UI has been inserted. For example, the detection unit 152 analyzes the content received by the reception unit 151, and detects that the additional UI has been inserted into the content.

For example, the detection unit 152 detects that the additional UI has been inserted into the system screen from software independent of the system. The content providing device 200 may implement this software. The detection unit 152 detects that a DOM of the system screen has been changed.

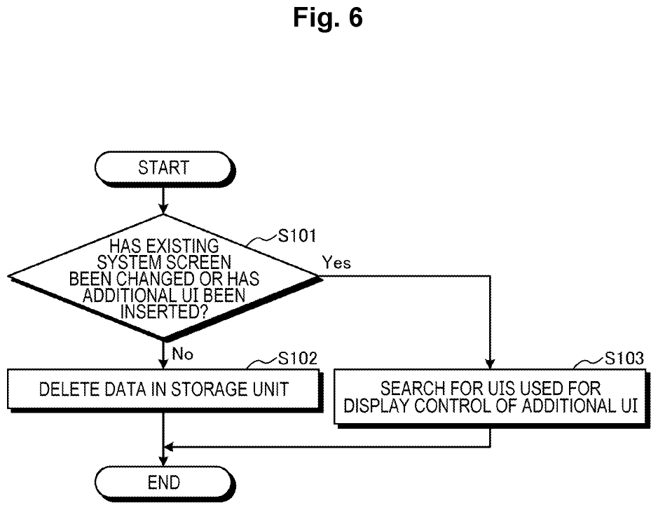

FIG. 6 is a flowchart illustrating an example of processing for detecting that an additional UI has been inserted performed by the terminal device 100 according to the embodiment.

The detection unit 152 of the terminal device 100 determines whether the existing system screen has been changed or an additional UI has been inserted (step S101).

In a case where it is determined that the existing system screen has not been changed and no additional UI has been inserted (step S101: No), the detection unit 152 deletes data in the storage unit 140 (step S102). In a case where it is determined that the existing system screen has been changed or an additional UI has been inserted (step S101: Yes), the search unit 154 to be described below searches for UIs used for display control of the additional UI (step S103). Thereafter, the detection unit 152 waits until the next change.

(Acquisition Unit 153)

The acquisition unit 153 acquires a DOM tree of content such as a screen of the system. For example, in a case where the detection unit 152 detects that an additional UI has been inserted into a screen, the acquisition unit 153 acquires a DOM tree of the screen of the system.

(Search Unit 154)

The search unit 154 searches for UIs used for display control of an additional UI. For example, the existing UIs used for display control of an additional UI are searched for from a DOM tree of a screen of the system. The existing UIs are UIs existing on the screen of the system. These existing UIs are used for display control of a UI added to the screen of the system.

As described in more detail below, the search unit 154 searches for the existing UIs in the DOM tree of the screen into which an additional UI has been inserted on the basis of a display condition related to display of the additional UI. For example, the display condition is a condition related to at least one of scrolling, transparency, or a size change of UIs positioned higher than a base point UI in the DOM tree. In other words, one or more of the display condition related to display of an additional UI may include at least one of 1) a condition related to scrolling of UIs positioned higher than a base point UI in the DOM tree, 2) a condition related to transparency of these UIs, or 3) a condition related to a size change of these UIs. The display condition may be the condition 1), the condition 2), the condition 3), or any combination thereof. Note that the display condition is not limited to these conditions. One or more of the display condition may include a condition other than these conditions (for example, condition related to z-index).

Inputs of a UI search are 1) a DOM tree acquired by the acquisition unit 153, 2) an existing UI serving as a base point of display of an additional UI (referred to as a base point UI), and 3) a display condition set for the additional UI. The search unit 154 searches for existing UIs used for display control of an additional UI as information related to the display control of the additional UI detected by the detection unit 152.

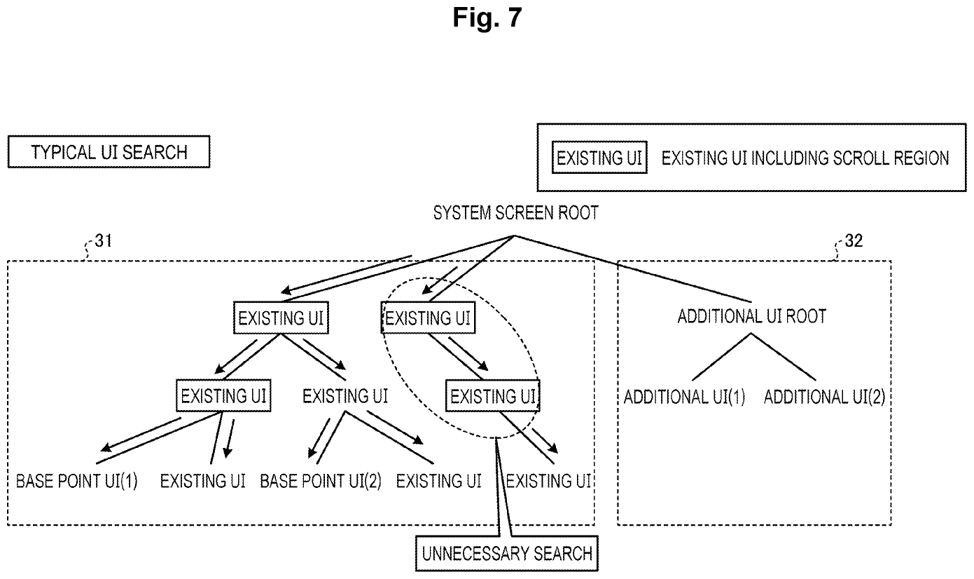

FIG. 7 is an explanatory diagram illustrating an example of a typical UI search. In the example of FIG. 7, a DOM tree of a system screen includes a DOM tree 31 of an existing system screen and a DOM tree 32 of additional UIs. In the typical UI search, the DOM tree of an existing system screen is exhaustively searched from the system screen root.

In the example of FIG. 7, in the typical UI search, an exhaustive search for existing UIs including scroll regions is performed. In a case where a base point UI is under the existing UIs including scroll regions, the display condition is stored in a storage device using the existing UIs as keys.

However, in the typical UI search, a useless search may be performed and search efficiency is poor. For example, in a case where a base point UI is not under existing UIs including scroll regions, the search of these existing UIs is an unnecessary search. As described above, in a case where a base point UI does not exist under the existing UIs, these existing UIs are irrelevant to display control processing of an additional UI. Therefore, the search of these existing UIs is originally unnecessary.

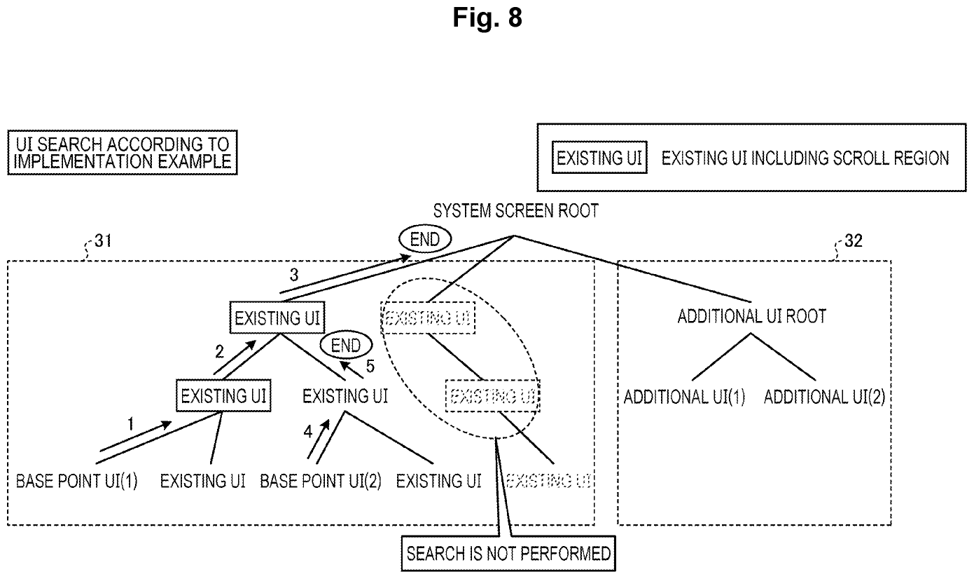

FIG. 8 is an explanatory diagram illustrating an example of a UI search according to the implementation example. Similar to the case of the typical UI search described above, a DOM tree of a system screen includes a DOM tree 31 of an existing system screen and a DOM tree 32 of additional UIs. In the UI search according to the implementation example, existing UIs related to display control processing of an additional UI are searched not from the system screen root but from a base point UI.

In the UI search according to the implementation example, the existing UIs related to display control processing are searched for from the base point UI toward the parents. In the UI search according to the implementation example, in a case where the search unit 154 finds 1) the system screen root, 2) a base point UI including the same condition, or 3) an existing UI that has been searched for under the same condition, the search unit 154 ends the search.

The search unit 154 performs processing of 1), 2), and 3) from all base point UIs. Then, display conditions corresponding to the display control processing are stored in the storage unit 140 using existing UIs as keys. As a result, the search unit 154 can eliminate a search for existing UIs irrelevant to the display control processing of the additional UI, thereby improving the search efficiency.

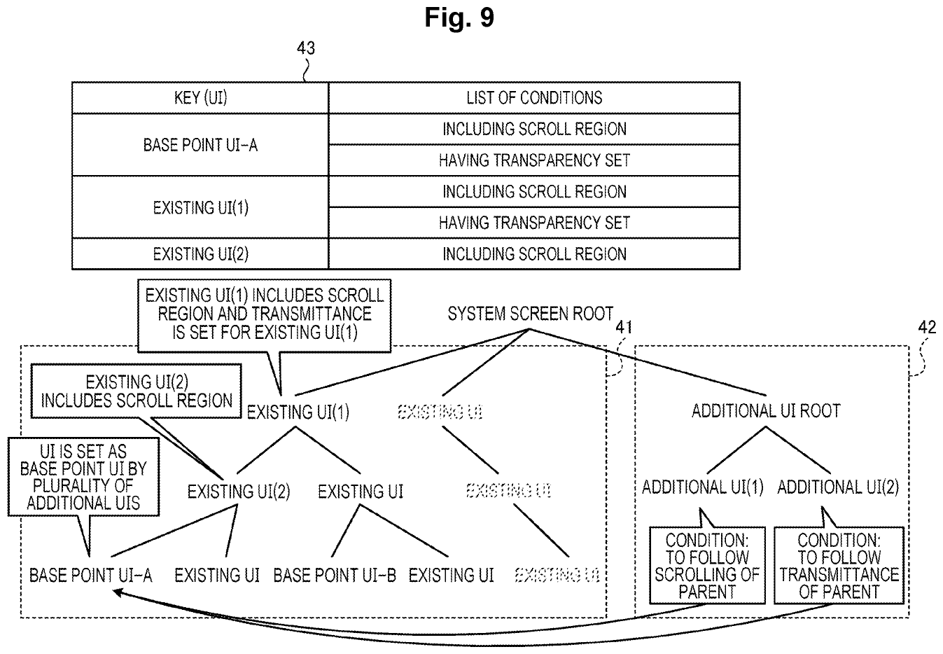

FIG. 9 is an explanatory diagram illustrating an example of information held in the storage unit 140. The search unit 154 stores display conditions in the display condition storage unit 141 in the storage unit 140. Display conditions 43 are an example of the display conditions stored in the display condition storage unit 141. The search unit 154 can register a plurality of conditions for one key as illustrated using the display conditions 43.

In the example of FIG. 9, a DOM tree of a system screen includes a DOM tree 41 of an existing system screen and a DOM tree 42 of additional UIs. The DOM tree 41 of the existing system screen includes a plurality of base point UIs and a plurality of existing UIs. The DOM tree 42 of additional UIs includes an additional UI (1) and an additional UI (2).

An existing UI (1) among the plurality of existing UIs includes a scroll region. Furthermore, the transmittance is set for the existing UI (1). An existing UI (2) among the plurality of existing UIs includes a scroll region.

A base point UI-A among the plurality of base point UIs is set as a base point UI by the additional UI (1) and the additional UI (2). A condition set for the additional UI (1) is to follow scrolling of the parent. On the other hand, a condition set for the additional UI (2) is to follow the transmittance of the parent.

The search unit 154 searches for existing UIs corresponding to a condition set for an additional UI from the base point UI. Then, the search unit 154 stores the display condition in the display condition storage unit 141 using a base point UI that has been searched as a key.

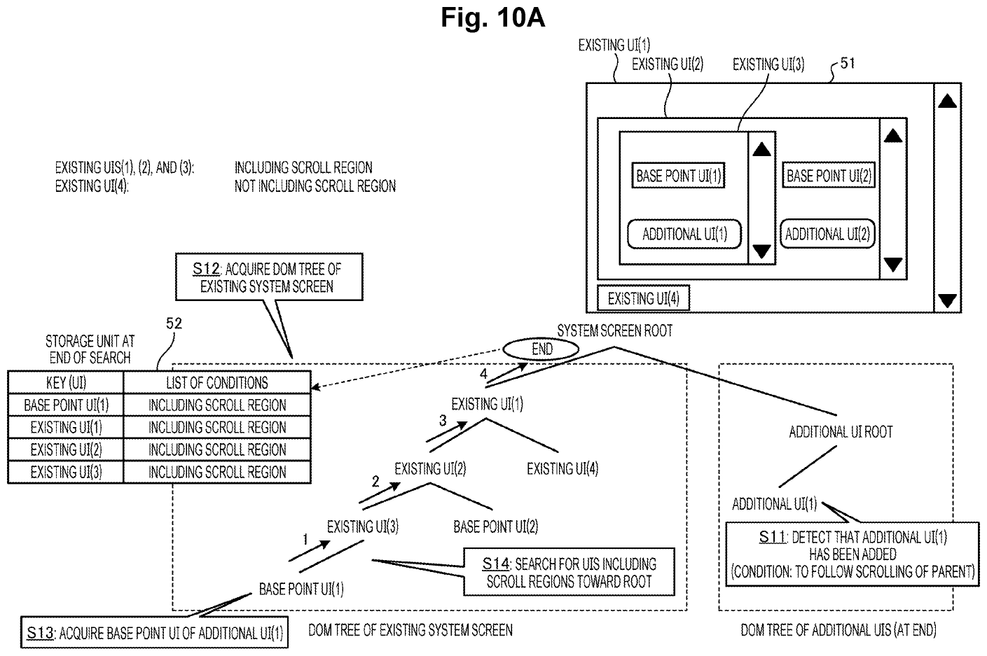

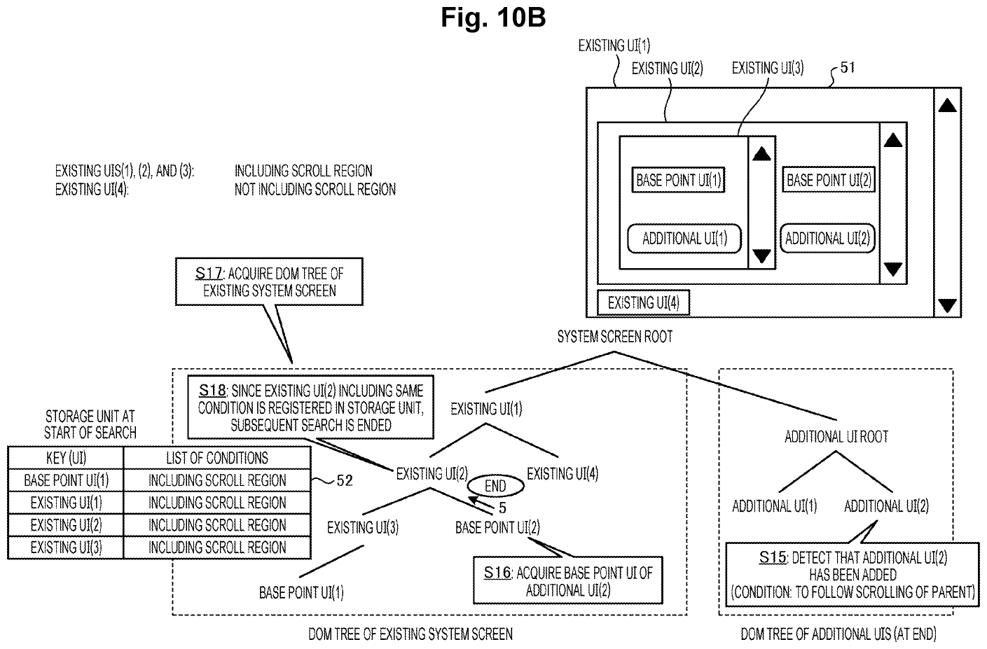

FIGS. 10A and 10B are explanatory diagrams illustrating examples of search processing of searching for UIs used for display control of additional UIs. In the examples of FIGS. 10A and 10B, conditions of the additional UIs are the same. A display condition set for an additional UI (1) is the same as a display condition set for an additional UI (2). The search unit 154 searches for UIs corresponding to the display condition from base point UI toward the root of a system screen. Then, the search unit 154 skips an existing UI that has already been searched and has the same condition.

In the examples of FIGS. 10A and 10B, a system screen 51 includes an existing UI (1). The existing UI (1) includes an existing UI (2) and an existing UI (4). The existing UI (2) includes an existing UI (3), a base point UI (2), and the additional UI (2). The existing UI (3) includes a base point UI (1) and the additional UI (1).

In the examples of FIGS. 10A and 10B, the existing UI (1), the existing UI (2), and the existing UI (3) include scroll regions. On the other hand, the existing UI (4) does not include a scroll region.

Referring to FIG. 10A, first, the search unit 154 detects that the additional UI (1) has been added to the existing system screen (step S11). A condition set for the additional UI (1) is to follow scrolling of the parent. A DOM tree of additional UIs is inserted at the end of a DOM tree of the existing system screen.

Next, the search unit 154 acquires the DOM tree of the existing system screen (step S12).

Next, the search unit 154 acquires a base point UI of the additional UI (1) (step S13). In the example of FIG. 10A, the search unit 154 acquires the base point UI (1). In the example of FIG. 10A, the search unit 154 stores the condition set for the additional UI (1) in the storage unit (for example, the display condition storage unit 141 in the storage unit 140) using the base point UI (1) as a key.

Next, the search unit 154 searches for UIs including scroll regions toward the system screen root (step S14). In the example of FIG. 10A, a route from the base point UI (1) to the system screen root includes the existing UI (1), the existing UI (2), and the existing UI (3). These existing UIs include scroll regions. Therefore, the search unit 154 stores conditions of “including a scroll region” in the storage unit using the existing UI (1), the existing UI (2), and the existing UI (3) as keys. In the example of FIG. 10A, the storage unit stores display conditions 52.

Referring to FIG. 10B, after step S14 in FIG. 10A, the search unit 154 detects that the additional UI (2) has been added to the existing system screen (step S15). A condition set for the additional UI (2) is to follow scrolling of the parent.

Next, the search unit 154 acquires the base point UI of the additional UI (2) (step S16). In the example of FIG. 10B, the search unit 154 acquires the base point UI (2).

Next, the search unit 154 acquires the DOM tree of the existing system screen (step S17).

Thereafter, the search unit 154 searches for UIs including scroll regions toward the system screen root. The storage unit at the start of the search stores the display conditions 52. In the example of FIG. 10B, the existing UI (2) is positioned in the parent of the base point UI (2). Since the existing UI (2) including the same condition is registered in the storage unit, the search unit 154 ends the subsequent search (step S18).

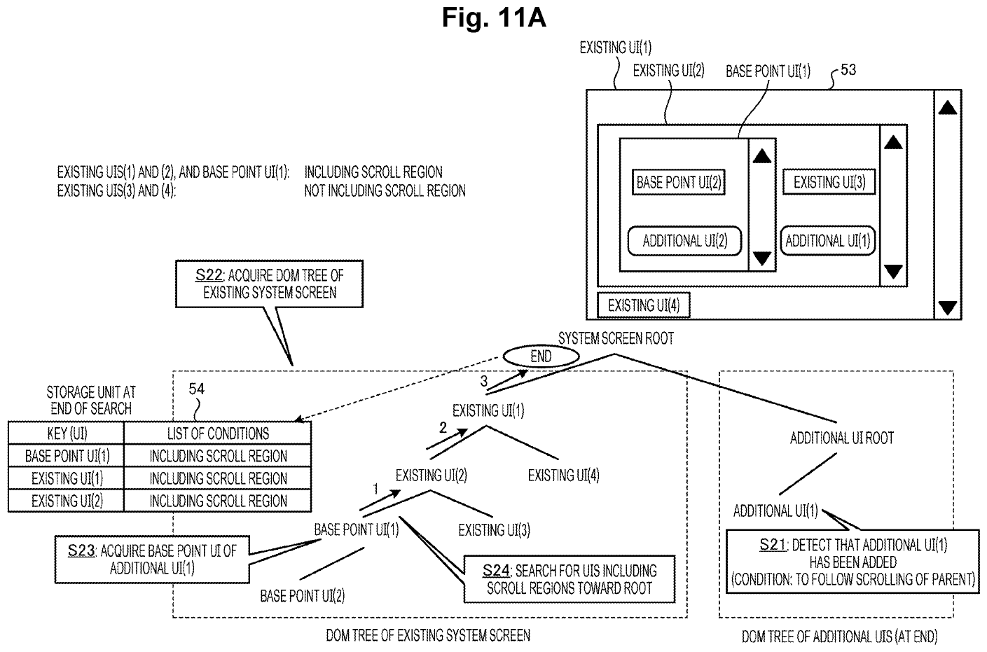

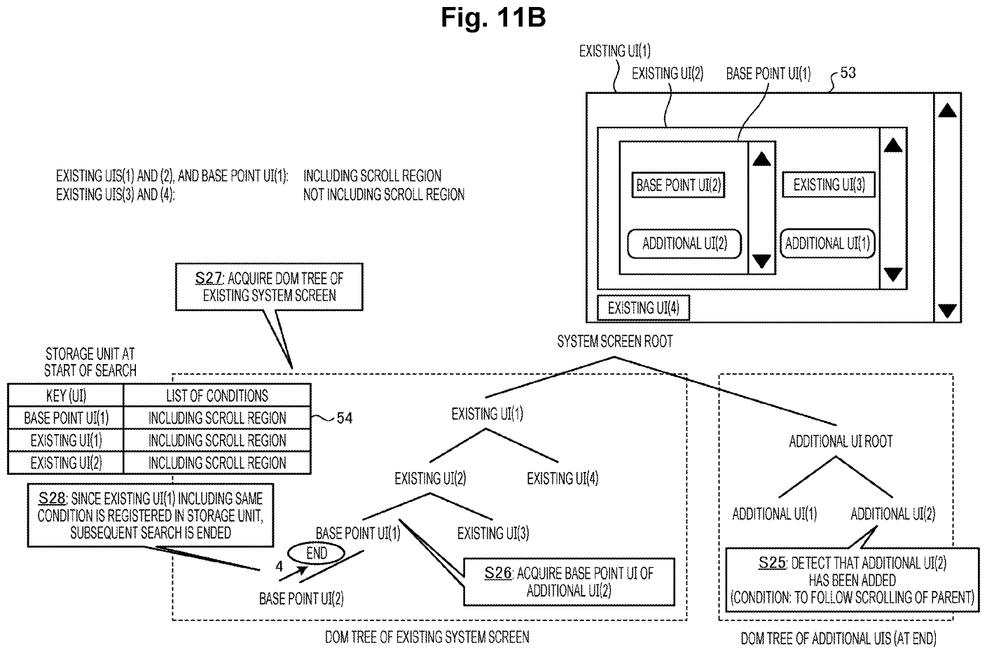

FIGS. 11A and 11B are explanatory diagrams illustrating examples of search processing of searching for UIs used for display control of additional UIs. In the examples of FIGS. 11A and 11B, conditions of the additional UIs are the same, and a plurality of base points are in a parent-child relationship. In a case where a base point UI that has been searched under the same condition is positioned in the parent, the search unit 154 skips the subsequent search.

In the examples of FIGS. 11A and 11B, a system screen 53 includes an existing UI (1). The existing UI (1) includes an existing UI (2) and an existing UI (4). The existing UI (2) includes a base point UI (1), an existing UI (3), and the additional UI (1). The base point UI (1) includes a base point UI (2) and an additional UI (2).

In the examples of FIGS. 11A and 11B, the existing UI (1), the existing UI (2), and the base point UI (1) include scroll regions. On the other hand, the existing UI (4) does not include a scroll region.

Referring to FIG. 11A, first, the search unit 154 detects that the additional UI (1) has been added to the existing system screen (step S21). A condition set for the additional UI (1) is to follow scrolling of the parent.

Next, the search unit 154 acquires the DOM tree of the existing system screen (step S22).

Next, the search unit 154 acquires the base point UI of the additional UI (1) (step S23). In the example of FIG. 11A, the search unit 154 acquires the base point UI (1). In the example of FIG. 11A, the search unit 154 stores the condition set for the additional UI (1) in the storage unit (for example, the display condition storage unit 141 in the storage unit 140) using the base point UI (1) as a key.

Next, the search unit 154 searches for UIs including scroll regions toward the system screen root (step S24). In the example of FIG. 11A, a route from the base point UI (1) to the system screen root includes the existing UI (1) and the existing UI (2). These existing UIs include scroll regions. Therefore, the search unit 154 stores conditions of “including a scroll region” in the storage unit using the existing UI (1) and the existing UI (2) as keys. In the example of FIG. 11A, the storage unit stores display conditions 54.

Referring to FIG. 11B, after step S24 in FIG. 11A, the search unit 154 detects that the additional UI (2) has been added to the existing system screen (step S25). A condition set for the additional UI (2) is to follow scrolling of the parent.

Next, the search unit 154 acquires the base point UI of the additional UI (2) (step S26). In the example of FIG. 11B, the search unit 154 acquires the base point UI (2).

Next, the search unit 154 acquires a DOM tree of the existing system screen (step S27).

Thereafter, the search unit 154 searches for UIs including scroll regions toward the system screen root. The storage unit at the start of the search stores the display conditions 54. In the example of FIG. 11B, the base point UI (1) is positioned in the parent of the base point UI (2). Since the base point UI (1) including the same condition is registered in the storage unit, the search unit 154 ends the subsequent search (step S28).

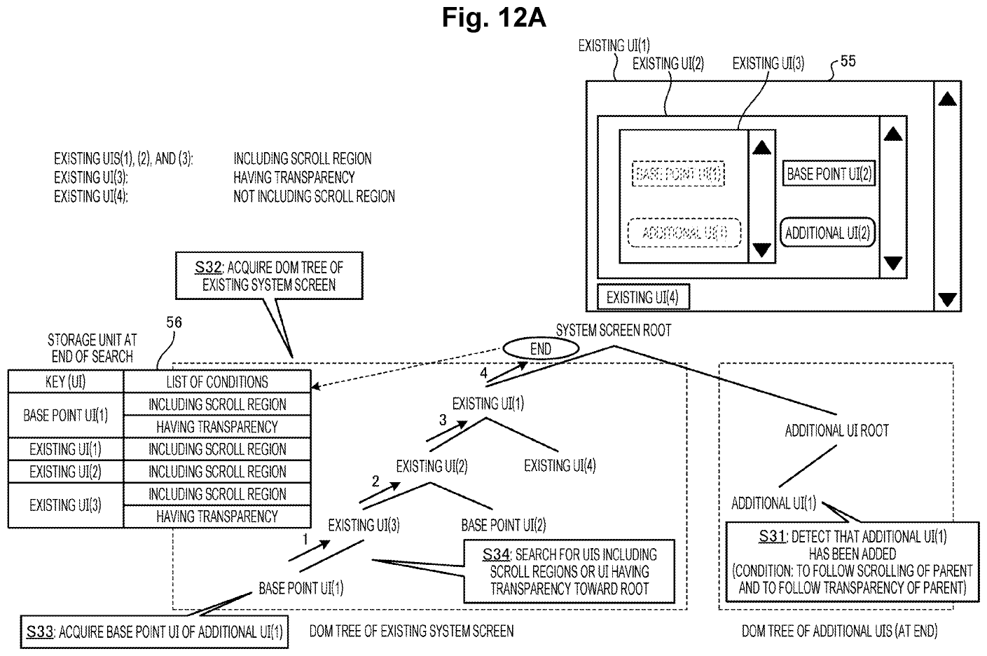

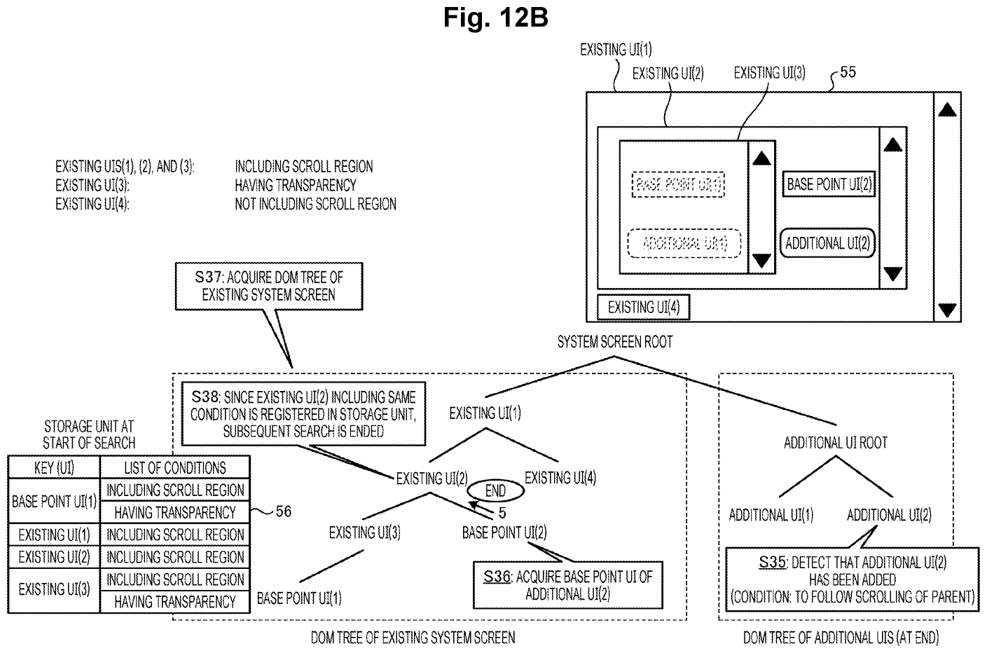

FIGS. 12A and 12B are explanatory diagrams illustrating examples of search processing of searching for UIs used for display control of additional UIs. In the examples of FIGS. 12A and 12B, there are a plurality of conditions in the additional UIs.

In the examples of FIGS. 12A and 12B, a system screen 55 includes an existing UI (1). The existing UI (1) includes an existing UI (2) and an existing UI (4). The existing UI (2) includes an existing UI (3), a base point UI (2), and the additional UI (2). The existing UI (3) includes a base point UI (1) and the additional UI (1).

In the examples of FIGS. 12A and 12B, the existing UI (1), the existing UI (2), and the existing UI (3) include scroll regions. In addition, the existing UI (3) has transparency. On the other hand, the existing UI (4) does not include a scroll region.

Referring to FIG. 12A, first, the search unit 154 detects that the additional UI (1) has been added to the existing system screen (step S31). A condition set for the additional UI (1) is to follow scrolling of the parent and to follow the transparency of the parent.

Next, the search unit 154 acquires a DOM tree of the existing system screen (step S32).

Next, the search unit 154 acquires the base point UI of the additional UI (1) (step S33). In the example of FIG. 12A, the search unit 154 acquires the base point UI (1). In the example of FIG. 12A, the search unit 154 stores the condition set for the additional UI (1) in the storage unit (for example, the display condition storage unit 141 in the storage unit 140) using the base point UI (1) as a key.

Next, the search unit 154 searches for UIs including scroll regions toward the system screen root (step S34). In the example of FIG. 12A, a route from the base point UI (1) to the system screen root includes the existing UI (3), the existing UI (2), and the existing UI (1). These existing UIs include scroll regions and have transparency. Therefore, the search unit 154 stores conditions of “including a scroll region” and conditions of “having transparency” in the storage unit using the existing UI (1), the existing UI (2), and the existing UI (3) as keys. In the example of FIG. 12A, the storage unit stores display conditions 56.

Referring to FIG. 12B, after step S34 in FIG. 12A, the search unit 154 detects that the additional UI (2) has been added to the existing system screen (step S35). A condition set for the additional UI (2) is to follow scrolling of the parent.

Next, the search unit 154 acquires the base point UI of the additional UI (2) (step S36). In the example of FIG. 12B, the search unit 154 acquires the base point UI (2).

Next, the search unit 154 acquires the DOM tree of the existing system screen (step S37).

Thereafter, the search unit 154 searches for UIs including scroll regions toward the system screen root. The storage unit at the start of the search stores the display conditions 56. In the example of FIG. 12B, the existing UI (2) is positioned in the parent of the base point UI (2). Since the existing UI (2) including the same condition is registered in the storage unit, the search unit 154 ends the subsequent search (step S38).

(Registration Unit 155)

The registration unit 155 registers processing of an event used for display control of an additional UI for UIs that have been searched for by the search unit 154. The registration unit 155 registers an event corresponding to a display condition of existing UIs. The registration unit 155 may store an event processing code used for display control of an additional UI in the event processing code storage unit 142.

(Display Unit 156)

The display unit 156 is implemented using, for example, a CPU, an MPU, or the like performing the event processing code described above using a RAM as a work area. For example, the event processing code described above causes the terminal device 100 to perform an event processing procedure according to a display condition. In this case, the display unit 156 is implemented using the event processing procedure.

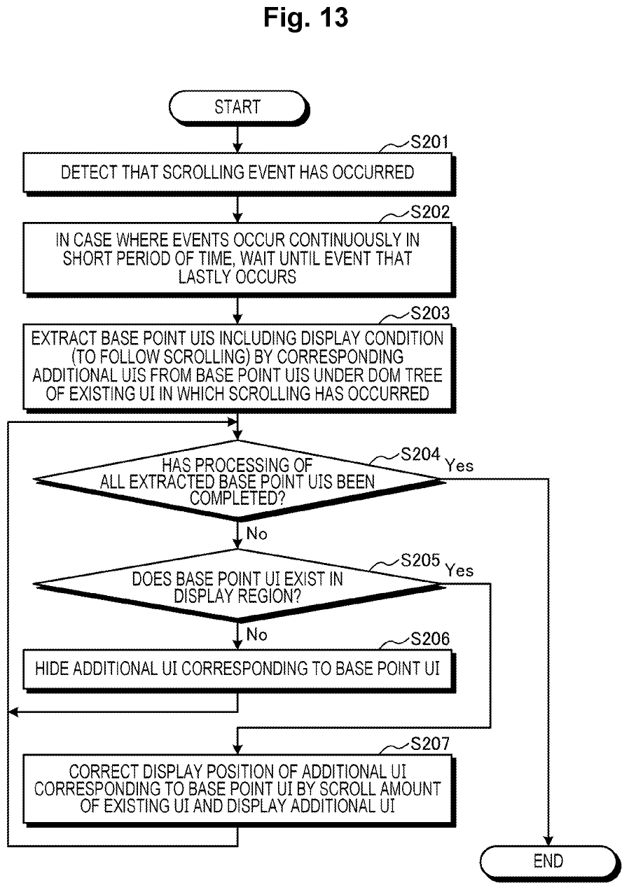

FIG. 13 is a flowchart illustrating an example of event processing according to a display condition performed by the terminal device 100 according to the embodiment. In the example of FIG. 13, the display condition is to follow scrolling. In a case where scrolling occurs in an existing UI, an additional UI follows the scrolling, and the display position of the additional UI is corrected.

First, the display unit 156 detects that a scrolling event has occurred (step S201). In a case where events occur continuously in a short period of time, the display unit 156 waits until the event that lastly occurs (step S202).

Next, the display unit 156 extracts base point UIs including the display condition (that is, to follow scrolling) by the corresponding additional UIs from base point UIs under a DOM tree of the existing UI in which the scrolling has occurred (step S203).

Next, the display unit 156 determines whether processing of all the extracted base point UIs has been completed (step S204).

In a case where it is determined that the processing of all the extracted base point UIs has not been completed (step S204: No), the display unit 156 determines whether a base point UI exists in the display region (step S205).

In a case where it is determined that a base point UI does not exist in the display region (step S205: No), the display unit 156 hides an additional UI corresponding to the base point UI (step S206). Then, the display unit 156 performs step S204 again.

In a case where it is determined that a base point UI exists in the display region (step S205: Yes), the display unit 156 corrects the display position of the additional UI corresponding to the base point UI by the scroll amount of the existing UI and displays the additional UI (step S207). Then, the display unit 156 performs step S204 again.

In a case where it is determined in step S204 that the processing of all the extracted base point UIs has been completed (step S204: Yes), the event processing according to the display condition ends.

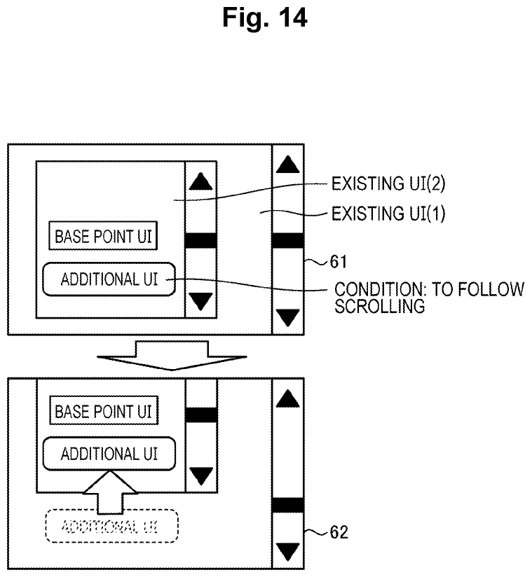

FIG. 14 is an explanatory diagram illustrating an example of screen display when an event occurs. Similarly to the case of FIG. 13, in the example of FIG. 14, the display condition is to follow scrolling. An additional UI is inserted into a screen 61. Furthermore, a base point UI is set for the additional UI. In a DOM tree of the screen 61, the base point UI is under an existing UI (1) and an existing UI (2).

In the example of FIG. 14, the event processing described above with reference to FIG. 13 is registered by the registration unit 155. When scrolling occurs, the system screen changes from the screen 61 to a screen 62. The display position of the additional UI is corrected according to the event processing as illustrated on the screen 62. Therefore, the event processing can prevent the additional UI from being left.

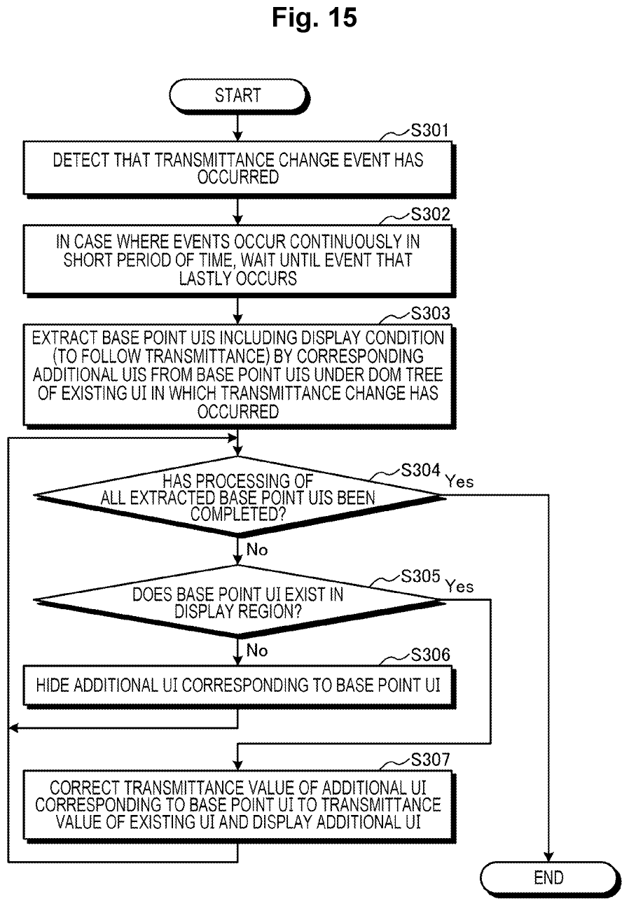

FIG. 15 is a flowchart illustrating an example of the event processing according to a display condition performed by the terminal device 100 according to the embodiment. In the example of FIG. 15, the display condition is to follow the transmittance. In a case where a change in the transmittance occurs in an existing UI, an additional UI follows the change in the transmittance, and the display of the additional UI is corrected.

First, the display unit 156 detects that a transmittance change event has occurred (step S301). In a case where events occur continuously in a short period of time, the display unit 156 waits until the event that lastly occurs (step S302).

Next, the display unit 156 extracts base point UIs including the display condition (that is, to follow the transmittance) by the corresponding additional UI from base point UIs under a DOM tree of the existing UI in which the transmittance change has occurred (step S303).

Steps S304, S305, and S306 are similar to steps S204, S205, and S206 in FIG. 13. Here, duplicate description will be omitted.

In a case where it is determined that a base point UI exists in the display region (step S305: Yes), the display unit 156 corrects the transmittance value of the additional UI corresponding to the base point UI to the transmittance value of the existing UI and displays the additional UI (step S307). Then, the display unit 156 performs step S304 again.

In a case where it is determined in step S304 that the processing of all the extracted base point UIs has been completed (step S304: Yes), the event processing according to the display condition ends.

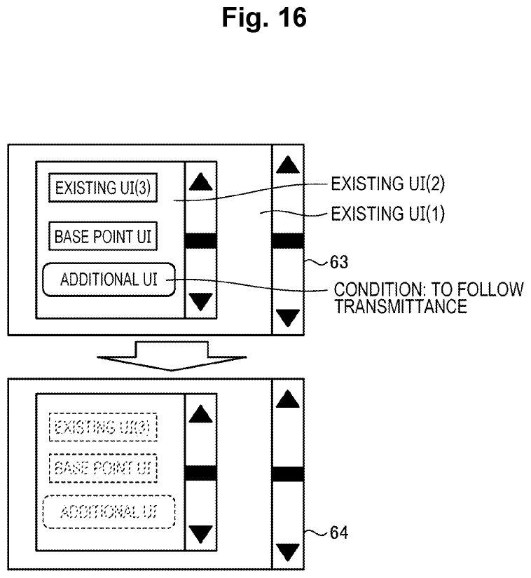

FIG. 16 is an explanatory diagram illustrating an example of screen display when an event occurs. Similarly to the case of FIG. 15, in the example of FIG. 16, the display condition is to follow the transmittance. An additional UI is inserted into a screen 63. Furthermore, a base point UI is set for the additional UI. In a DOM tree of the screen 63, the base point UI is under an existing UI (1) and an existing UI (2). Furthermore, an existing UI (3) is also under the existing UI (1) and the existing UI (2).

In the example of FIG. 16, the event processing described above with reference to FIG. 15 is registered by the registration unit 155. When the transmittance of the existing UI (2) changes, the colors of the existing UI (3) and the base point UI also change. If the event processing is not registered, the color of the existing UI (3) around the additional UI changes depending on the transmittance of the existing UI (2), but the color of the additional UI does not change. In such a case, the additional UI is displayed in a conspicuous manner. In a case where the event processing is registered, the system screen changes from the screen 63 to a screen 64. The event processing is applied and the additional UI is displayed naturally. Therefore, the event processing can prevent the additional UI from being conspicuous on the system screen.

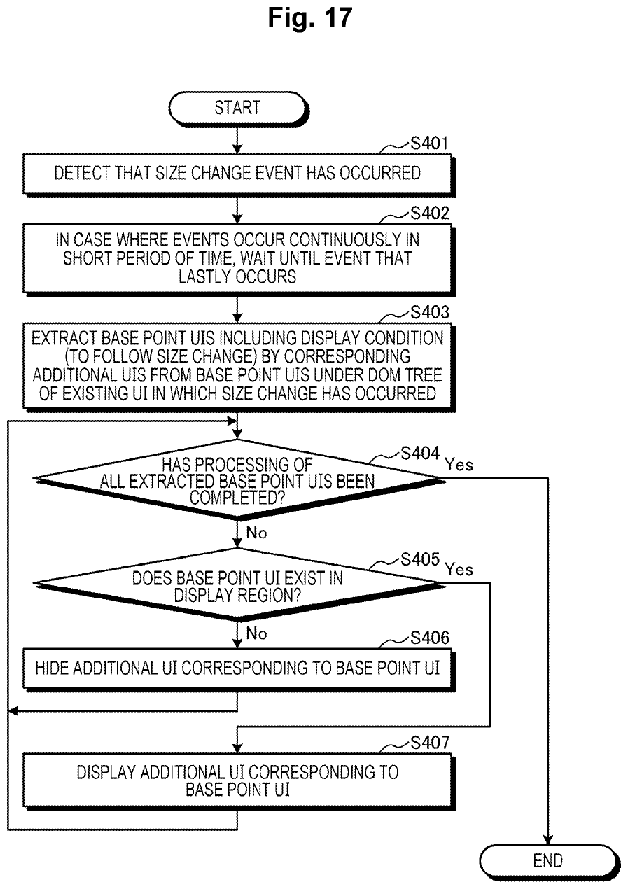

FIG. 17 is a flowchart illustrating an example of the event processing according to a display condition performed by the terminal device 100 according to the embodiment. In the example of FIG. 17, the display condition is to follow a size change. In a case where a size change occurs in an existing UI, an additional UI follows the size change, and the display of the additional UI is corrected.

First, the display unit 156 detects that a size change event has occurred (step S401). In a case where events occur continuously in a short period of time, the display unit 156 waits until the event that lastly occurs (step S402).

Next, the display unit 156 extracts base point UIs of the display condition (that is, to follow a size change) by the corresponding additional UI from base point UIs under a DOM tree of the existing UI in which the size change has occurred (step S403).

Steps S404, S405, and S406 are similar to steps S204, S205, and S206 in FIG. 13. Here, duplicate description will be omitted.

In a case where it is determined that a base point UI exists in the display region (step S405: Yes), the display unit 156 displays an additional UI corresponding to the base point UI (step S407). Then, the display unit 156 performs step S404 again.

In a case where it is determined in step S404 that the processing of all the extracted base point UIs has been completed (step S404: Yes), the event processing according to the display condition ends.

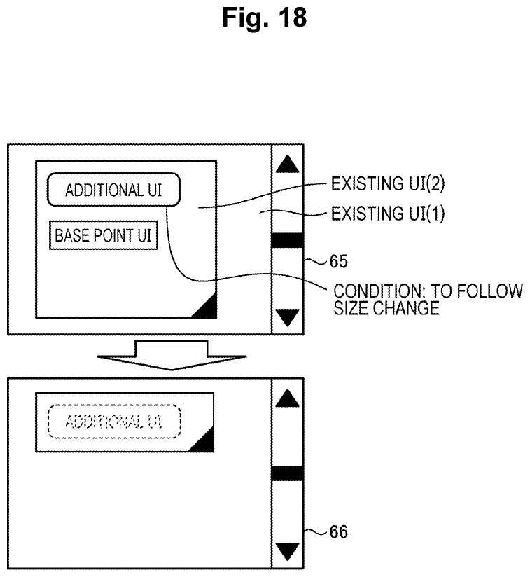

FIG. 18 is an explanatory diagram illustrating an example of screen display when an event occurs. Similarly to the case of FIG. 17, in the example of FIG. 18, the display condition is to follow a size change. An additional UI is inserted into a screen 65. Furthermore, a base point UI is set for the additional UI. In a DOM tree of the screen 65, the base point UI is under an existing UI (1) and an existing UI (2).

In the example of FIG. 18, the event processing described above with reference to FIG. 17 is registered by the registration unit 155. In a case where the size of the existing UI (2) changes, the system screen changes from the screen 65 to a screen 66. In the example of FIG. 18, the base point UI is outside the display region. The additional UI is set to be hidden according to the event processing as illustrated on the screen 65.

### 4. Flow of Search Processing

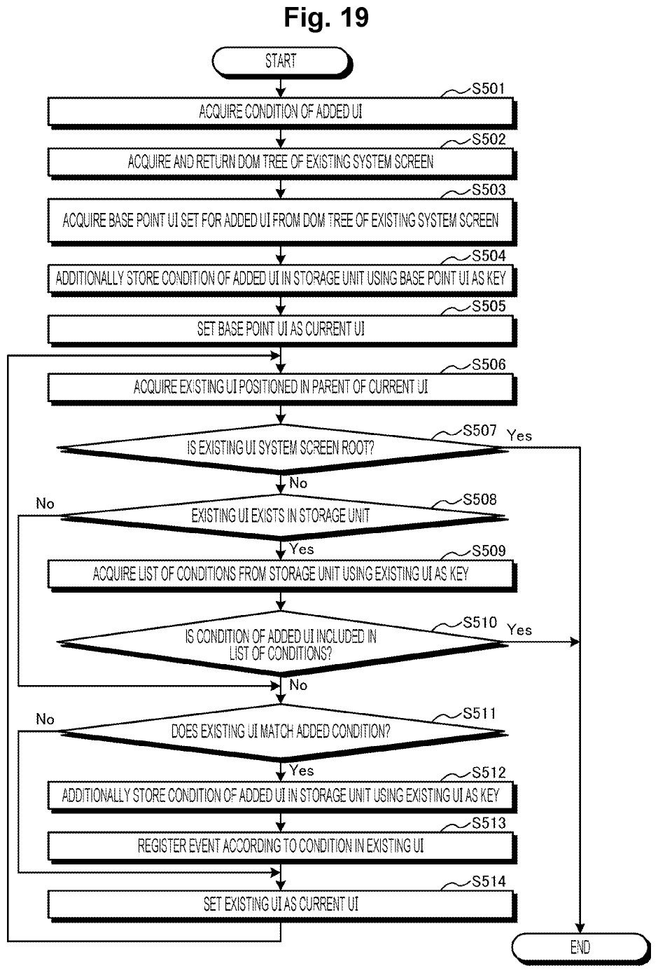

Next, a procedure of search processing by the terminal device 100 according to the embodiment will be described with reference to FIG. 19.

FIG. 19 is a flowchart illustrating an example of processing for searching for UIs used for display control of an additional UI performed by the terminal device 100 according to the embodiment.

As illustrated in FIG. 19, first, the acquisition unit 153 of the terminal device 100 acquires a condition of an added UI (step S501). More specifically, the acquisition unit 153 acquires a display condition of the added UI (that is, an additional UI described above).

Next, the acquisition unit 153 acquires and returns a DOM tree of an existing system screen (step S502).

Next, the search unit 154 of the terminal device 100 acquires a base point UI set for the added UI from the DOM tree of the existing system screen (step S503). As described above, the base point UI is a UI serving as a base point of display of the added UI.

Next, the search unit 154 additionally stores the condition of the added UI in the storage unit 140 using the base point UI as a key (step S504). More specifically, the search unit 154 stores the display condition of the added UI in the display condition storage unit 141 using the base point UI as a key.

Next, the search unit 154 sets the base point UI as a current UI (step S505). In other words, the search unit 154 sets the base point UI as a search point. As described above, the base point UI corresponds to a search starting point.

Next, the search unit 154 acquires an existing UI positioned in the parent of the current UI (step S506).

Next, the search unit 154 determines whether the acquired existing UI is the system screen root (step S507). In a case where it is determined that the acquired existing UI is the system screen root (step S507: Yes), the processing for searching for UIs used for display control of the additional UI ends.

In a case where it is determined that the acquired existing UI is not the system screen root (step S507: No), the search unit 154 determines whether the existing UI exists in the storage unit 140 (step S508). More specifically, the search unit 154 determines whether the existing UI is stored as a key in the display condition storage unit 141.

In a case where it is determined that the existing UI exists in the storage unit 140 (step S508: Yes), the search unit 154 acquires a list of conditions from the storage unit 140 using the existing UI as a key (step S509). The list of conditions is, for example, display conditions such as “including a scroll region” and “the transparency is set”.

Next, the search unit 154 determines whether the condition of the added UI is included in the acquired list of conditions (step S510).

In a case where it is determined that the condition of the added UI is not included in the acquired list of conditions (step S510: No), the search unit 154 determines whether the existing UI matches the added condition (step S511). As an example, in a case where the condition of the added UI is “to follow scrolling of the parent”, the search unit 154 determines whether the existing UI includes a scroll region.

In a case where it is determined in step S508 that the existing UI does not exist in the storage unit 140 (step S508: No), the processing for searching for UIs used for display control of the additional UI proceeds to step S511.

In a case where it is determined that the existing UI matches the added condition (step S511: Yes), the search unit 154 additionally stores the condition of the added UI in the storage unit 140 using the existing UI as a key (step S512). As an example, in a case where the condition of the added UI is “to follow scrolling of the parent” and the existing UI includes a scroll region, the search unit 154 stores the display condition of “including a scroll region” associated with the existing UI in the display condition storage unit 141.

Next, the registration unit 155 of the terminal device 100 registers an event according to the condition for the existing UI (step S513). As described above with reference to FIG. 5, for example, the registration unit 155 registers the event processing used for display control of the added UI for the event of the existing UI (for example, scrolling). For example, the registration unit 155 stores a code of the event processing in a case where a specific event (for example, scrolling) occurs in the event processing code storage unit 142.

Next, the search unit 154 of the terminal device 100 sets the existing UI as a current UI (step S514). Then, the search unit 154 performs step S506 again.

In a case where it is determined in step S510 that the condition of the added UI is included in the acquired list of conditions (step S510: Yes), the processing for searching for UIs used for display control of the additional UI ends.

### 5. Effects

As described above, the display control system 1 according to the embodiment includes the acquisition unit 153 and the search unit 154.

In the display control system 1 according to the embodiment, the acquisition unit 153 acquires a DOM tree of the screen into which an additional UI has been inserted. Furthermore, in the display control system 1 according to the embodiment, the search unit 154 searches for UIs used for display control of the additional UI from a base point UI serving as the base point of display of the additional UI in the DOM tree on the basis of the display condition related to display of the additional UI.

As a result, the display control system 1 according to the embodiment can efficiently search for UIs used for display control of an additional UI.

Furthermore, in the display control system 1 according to the embodiment, the search unit 154 recursively searches for UIs used for display control of an additional UI from the base point UI toward the root of the DOM tree, stores a display condition in a predetermined storage device (for example, the display condition storage unit 141) using the base point UI as a key, and stores display conditions in the predetermined storage device using the UIs that have been searched for as keys.

As a result, the display control system 1 according to the embodiment can greatly reduce a useless search and implement an efficient search for an existing UI search used for display control of an additional UI used in the UI extension.

Furthermore, in the display control system 1 according to the embodiment, the acquisition unit 153 acquires a DOM tree of the screen into which another additional UI has been inserted in addition to the additional UI. Furthermore, in the display control system 1 according to the embodiment, in a case where the display condition related to display of the another additional UI matches the display condition stored in a predetermined storage device (for example, the display condition storage unit 141), the search unit 154 ends the search for UIs used for display control of another addition.

As a result, the display control system 1 according to the embodiment can speed up display of an additional UI and reduce the load in a case where the UI extension is applied to the screen.

Furthermore, in the display control system 1 according to the embodiment, the display condition related to display of an additional UI is a condition related to at least one of scrolling, transparency, or a size change of UIs positioned higher than a base point UI in the DOM tree.

As a result, the display control system 1 according to the embodiment can control display of an additional UI according to a display situation of a parent element that used not to be the target of the display control, such as the transmittance, the size change, or the z-index. Therefore, the display control system 1 can display an additional UI more naturally in the existing system.

Furthermore, the display control system 1 according to the embodiment includes the detection unit 152 that detects that an additional UI has been inserted into the screen. Furthermore, in the display control system 1 according to the embodiment, in a case where the detection unit 152 detects that an additional UI has been inserted into the screen, the acquisition unit 153 acquires a DOM tree of the screen.

As a result, the display control system 1 according to the embodiment can perform display control of an additional UI even in a case where the UI is dynamically added.

### 6. Other Embodiments

The display control system 1 according to the embodiment described above may be implemented in various different modes other than the embodiment described above. Therefore, another embodiment of the above display control system 1 will be described below.

[6-1. Performance Subject of Display Control Processing by Terminal Device]

The content providing device 200 may perform all or a part of the processing performed by the terminal device 100 in the embodiment described above. For example, the content providing device 200 may perform all or part of the information processing described above for the reception unit 151, the detection unit 152, the acquisition unit 153, the search unit 154, and the registration unit 155.

As an example, the content providing device 200 may receive content from another content providing device. Then, the content providing device 200 may perform the information processing described above for the detection unit 152, the acquisition unit 153, the search unit 154, and the registration unit 155 using the received content.

The content providing device 200 may generate the event processing code described above, and provide content to the terminal device 100 together with the generated event processing code. In this case, the information processing described above may be performed for the display unit 156 on the basis of the content and the event processing code provided from the terminal device 100 and the content providing device 200.

As described above with reference to FIG. 5, the display control system 1 includes the terminal device 100 and the content providing device 200. The content providing device 200 may share a part of the information processing described above for the reception unit 151, the detection unit 152, the acquisition unit 153, the search unit 154, and the registration unit 155.

### 7. Others

Furthermore, among the processing described in the above embodiment, a part of the processing described as being automatically performed can also be manually performed. Alternatively, all or part of the processing described as being performed manually can be automatically performed by a known method. In addition, the processing procedures, the specific names, and the information including various data and parameters illustrated in the specification and the drawings can be freely changed unless otherwise specified. For example, the various types of information illustrated in the drawings are not limited to the illustrated information.

Furthermore, each component of each device that has been illustrated is functionally conceptual, and is not necessarily physically formed as illustrated. That is, a specific form of distribution and integration of individual devices is not limited to the illustrated form, and all or a part of the configuration can be functionally or physically distributed and integrated in any unit according to various loads, usage conditions, and the like.

For example, a part of or the entire storage unit 140 illustrated in FIG. 5 may be held in a storage server or the like instead of being held by the terminal device 100. In this case, the terminal device 100 accesses the storage server and acquires various types of information such as display conditions.

### 8. Hardware Configuration

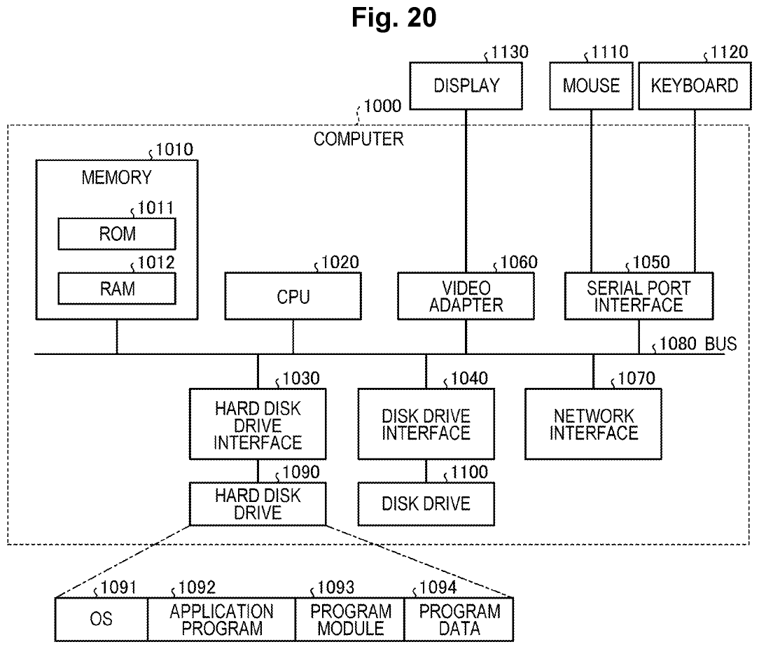

FIG. 20 is a diagram illustrating an example of a hardware configuration. The terminal device 100 and the content providing device 200 according to the embodiment described above are implemented using, for example, a computer 1000 having a configuration as illustrated in FIG. 20.

FIG. 20 illustrates an example of the computer in which the terminal device 100 and the content providing device 200 are implemented by performing a program. The computer 1000 has, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected with a disk drive 1100. For example, a removable storage medium such as a magnetic disk or an optical disk is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an operating system (OS) 1091, an application program 1092, a program module 1093, and program data 1094. That is, the program that defines processing by the terminal device 100 and the content providing device 200 is implemented as the program module 1093 in which a code performable by the computer 1000 is described. The program module 1093 is stored in, for example, the hard disk drive 1090. For example, the program module 1093 for performing processing similar to the functional configuration in the terminal device 100 or the content providing device 200 is stored in the hard disk drive 1090. Note that the hard disk drive 1090 may be replaced with a solid state drive (SSD).

Furthermore, setting data used in the processing of the embodiment described above is stored, for example, in the memory 1010 or the hard disk drive 1090 as the program data 1094. Then, the CPU 1020 reads and performs the program module 1093 and the program data 1094 stored in the memory 1010 and the hard disk drive 1090 to the RAM 1012 as necessary.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (e.g., LAN or WAN). Then, the program module 1093 and the program data 1094 may be read by the CPU 1020 from the another computer via the network interface 1070.

Although some embodiments of the present application have been described above in detail with reference to the drawings, these are merely examples, and the present invention is not limited to specific examples. The features described in the present specification can be implemented in other forms with various modifications and improvements on the basis of knowledge of those skilled in the art, including the aspects described in the section “Description of Embodiments”.

Furthermore, the “sections”, “modules”, and “units” described above can be read as “means”, “circuits”, or the like. For example, the search unit can be read as search means or a search circuit.

### REFERENCE SIGNS LIST

1 Display control system
100 Terminal device
110 Communication unit
120 Input unit
130 Output unit
140 Storage unit
141 Display condition storage unit
142 Event processing code storage unit
150 Control unit
151 Reception unit
152 Detection unit
153 Acquisition unit
154 Search unit
155 Registration unit
156 Display unit
200 Content providing device

1. A display control system comprising:
an acquisition unit, including one or more processors, configured to acquire a document object model (DOM) tree of a screen into which an additional user interface (UI) is inserted; and
a search unit, including one or more processors, configured to search for UIs used for display control of the additional UI from a base point UI serving as a base point of display of the additional UI in the DOM tree on a basis of a display condition related to display of the additional UI.

2. The display control system according to claim 1,
wherein the search unit is configured to recursively search for UIs used for display control of the additional UI from the base point UI toward a root of the DOM tree, store the display condition in a predetermined storage device using the base point UI as a key, and store the display condition in the predetermined storage device using UIs that have been searched for as keys.

3. The display control system according to claim 2,
wherein the acquisition unit is configured to acquire the DOM tree of the screen into which another additional UI is inserted in addition to the additional UI; and
the search unit is configured to end a search for UIs used for display control of the another addition in a case where a display condition related to display of the another additional UI matches a display condition stored in the predetermined storage device.

4. The display control system according to claim 1,
wherein a display condition related to display of the additional UI is a condition related to at least one of scrolling, transparency, or a size change of UIs positioned higher than the base point UI in the DOM tree.

5. The display control system according to claim 1, further comprising a detection unit, including one or more processors, configured to detect that the additional UI has been inserted into the screen,
wherein the acquisition unit is configured to acquire a DOM tree of the screen in a case where the detection unit detects that the additional UI has been inserted into the screen.

6. A display control method performed by a computer, comprising:
acquiring a DOM tree of a screen into which an additional UI is inserted; and
searching for UIs used for display control of the additional UI from a base point UI serving as a base point of display of the additional UI in the DOM tree on a basis of a display condition related to display of the additional UI.

7. A non-transitory computer-readable storage medium storing a display control program that causes a computer to perform procedures, the procedures comprising:
acquiring a DOM tree of a screen into which an additional UI is inserted; and
searching for UI used for display control of the additional UI from a base point UI serving as a base point of display of the additional UI in the DOM tree on a basis of a display condition related to display of the additional UI.

8. The display control method according to claim 6, further comprising:
recursively searching for UIs used for display control of the additional UI from the base point UI toward a root of the DOM tree, storing the display condition in a predetermined storage device using the base point UI as a key, and storing the display condition in the predetermined storage device using UIs that have been searched for as keys.

9. The display control method according to claim 8,
wherein the acquisition unit acquires the DOM tree of the screen into which another additional UI is inserted in addition to the additional UI; and
the method further comprises ending a search for UIs used for display control of the another addition in a case where a display condition related to display of the another additional UI matches a display condition stored in the predetermined storage device.

10. The display control method according to claim 6,
wherein a display condition related to display of the additional UI is a condition related to at least one of scrolling, transparency, or a size change of UIs positioned higher than the base point UI in the DOM tree.

11. The display control method according to claim 6, further comprising:
detecting that the additional UI has been inserted into the screen; and
in response to detecting that the additional UI has been inserted into the screen, acquiring a DOM tree of the screen.

12. The non-transitory computer-readable storage medium according to claim 7, wherein the procedures further comprise:
recursively searching for UIs used for display control of the additional UI from the base point UI toward a root of the DOM tree, storing the display condition in a predetermined storage device using the base point UI as a key, and storing the display condition in the predetermined storage device using UIs that have been searched for as keys.

13. The non-transitory computer-readable storage medium according to claim 12,
wherein the acquisition unit acquires the DOM tree of the screen into which another additional UI is inserted in addition to the additional UI; and
the procedures further comprise ending a search for UIs used for display control of the another addition in a case where a display condition related to display of the another additional UI matches a display condition stored in the predetermined storage device.

14. The non-transitory computer-readable storage medium according to claim 7,
wherein a display condition related to display of the additional UI is a condition related to at least one of scrolling, transparency, or a size change of UIs positioned higher than the base point UI in the DOM tree.

15. The non-transitory computer-readable storage medium according to claim 7, wherein the procedures further comprise:
detecting that the additional UI has been inserted into the screen; and
in response to detecting that the additional UI has been inserted into the screen, acquiring a DOM tree of the screen.
